(19) United States
(12) Patent Application Publication
(10) Pub. No.: US 2026/0364971 A1
(43) Pub. Date: Nov. 19, 2026

(54) INTEGRATED CARBON FIBER SPOKED WHEEL AND MOTOR STRUCTURE

(71) Applicant: Suzhou Jinqiutiao Technology Co., Ltd., Kunshan City (CN)

(72) Inventors: SHIH-CHIEH CHU, New Taipei City (TW); MAO-ZHEN LI, Kunshan City (CN)

(21) Appl. No.: 19/730,890

(22) Filed: Jul. 3, 2026

(30) Foreign Application Priority Data
Jul. 4, 2025 (CN) 2025213992456

(51) Int. Cl. B60B 1/00; B62L 1/00; B62M 6/65

(52) U.S. Cl. CPC B60B 1/003; B62L 1/00; B62M 6/65

(57) ABSTRACT

Disclosed is an integrated carbon fiber spoked wheel and motor structure, including a carbon fiber hub, a driving motor arranged at the center of the carbon fiber hub, a disc brake mount, a rotor cover arranged between the disc brake mount and the carbon fiber hub, a retaining ring, a bearing arranged at the center of the disc brake mount, an axle, and an end cap lockingly secured to the motor housing. The driving motor includes a motor housing with a polygonal outer contour fitting with an inner edge of the carbon fiber hub. When the driving motor is at the center of the carbon fiber hub, the retaining ring is locked by the motor housing, and the motor housing is press-fit secured to the center of the carbon fiber hub. The disc brake mount is lockingly secured to the motor housing.

### TECHNICAL FIELD

The invention relates to a hub structure for electric assist bicycles, particularly to a carbon fiber hub, and in particular to a structure in which a carbon fiber hub and a driving motor are integrated into a single unit.

### BACKGROUND

In the field of lightweight and high-performance design for electric assist bicycles, carbon fiber is widely used for hub manufacturing due to its light weight, high strength, and corrosion resistance. However, a technical barrier has existed in its integration with the driving motor for a long time. Traditional carbon fiber rear hubs typically feature a single-load-bearing structure design, in which the geometry and stress distribution of the central region of a hub are optimized solely for rotational support. The driving motor, as the core power unit, has a metal housing of a circular contour that poorly fits with the center of the carbon fiber hub, making it difficult to achieve a rigid integration between the components by means of any conventional mechanical connection. In the prior art, a motor is typically mounted as a separate external unit on the outside of the frame or the hub and connected to the hub by means of transmission components such as a chain and gears. This separated structure not only increases the number of components and assembling complexity but also results in a longer power transmission path and greater energy loss. In addition, the exposed motor components are susceptible to damage from external environmental factors such as rain and mud, which affects the system's reliability.

Further, the processing characteristics of carbon fiber materials (such as fiber orientation control during compression molding and the bond strength at composite interfaces) make it difficult to balance the structural strength and the assembling precision when it is needed to reserve a space inside the hub for the motor. If a traditional metal motor housing is forcibly embedded directly into a carbon fiber hub, differences in the thermal expansion coefficients of the materials (the thermal expansion rates of metal and carbon fiber differ by approximately one order of magnitude) might lead to loosening or cracking during long-term use, or cause localized fatigue failure of the hub due to stress concentration from vibrations generated during motor operation. In addition, in this split-structure design, the motor is cooled mainly by natural air convection, while the enclosed structure of the carbon fiber hub tends to create cooling dead zones. As a result, the motor will be overheated during high-load operation, which in turn affects the demagnetization of the magnets and the service life of the winding insulation, thereby limiting the driving mileage and power output stability of electric assist bicycles.

As the global electric two-wheeler market increasingly embraces design concepts centered on “lightweight integration” and “high efficiency with low energy consumption”, the conventional “motor-hub separation” technical solutions can no longer meet the demands of high-end electric assist bicycles for balanced weight distribution (for example, integrating the motor into the rear wheel to optimize the front-to-rear load distribution and improve the maneuverability), space utilization efficiency (for example, eliminating the external motor mount to free up the frame space for the battery), and riding experience (for example, reducing drive noise and improving responsiveness). Therefore, overcoming the bottleneck of structural compatibility between the carbon fiber hub and the driving motor to achieve their high-strength integration and functional synergy has become an urgent technical challenge for the industry.

### SUMMARY

To address this challenge, the invention provides an integrated carbon fiber spoked wheel and motor structure, including a carbon fiber hub and a driving motor. The driving motor is arranged at the center of the carbon fiber hub and includes a motor housing. The integrated structure further includes a disc brake mount, a rotor cover, a retaining ring, a bearing, an axle, and an end cap. The motor housing has a polygonal outer contour that fits with an inner edge at the center of the carbon fiber hub. The motor housing includes a first end and a second end. The first end of the motor housing is provided with an internal thread. An abutment flange is provided on the outer circumference of the first end of the motor housing. The second end of the motor housing is provided with an external thread. When the driving motor is arranged at the center of the carbon fiber hub, the second end of the motor housing protrudes out of the carbon fiber hub. The retaining ring is locked from the outside toward the inside at the second end of the motor housing, and the motor housing is press-fit secured to the center of the carbon fiber hub by the retaining ring and the abutment flange on the first end of the motor housing. The disc brake mount includes a first end and a second end. The first end of the disc brake mount is provided with an internal thread and is lockingly secured to the second end of the motor housing. The rotor cover is arranged between the disc brake mount and the carbon fiber hub. The bearing is arranged at the center of the disc brake mount, and the axle passes through the bearing and extends to the first end of the motor housing. The end cap is lockingly secured to the first end of the motor housing.

The integrated structure further includes a freehub, one end of which is snap-fit secured to an inner edge at the center of the end cap.

Further, a clamping flange is provided between the first end of the disc brake mount and the second end of the disc brake mount; and the first end of the disc brake mount is inserted into the rotor cover and locked with the external thread at the second end of the motor housing, thereby securing the rotor cover between the carbon fiber hub and the disc brake mount by means of the clamping flange.

Further, the integrated structure includes a locking fastener, which fits over one end of the axle from the outside of the freehub toward the inside.

Further, the motor housing may be of a pentagonal, hexagonal, heptagonal, octagonal, nonagonal, or decagonal shape.

Further, the end cap includes a fixing end, which is provided with an external thread that is lockingly secured to the internal thread at the first end of the motor housing.

Further, the rotor cover is of a conical shape, and the diameter of one end of the rotor cover, close to the carbon fiber hub, is greater than that of the other end of the rotor cover, close to the disc brake mount.

Further, spoiler ribs are arranged on a surface of the rotor cover.

Further, the motor housing is bondingly secured to the center of the carbon fiber hub.

With an innovative structural design, this technical solution achieves an efficient integration of the carbon fiber hub and the motor to address the technical challenge described above. The beneficial effects of the invention include:
(1) Integrated lightweight design: The driving motor is embedded at the center of the carbon fiber hub, and the polygonal housing precisely fits with the inner edge of the hub, thereby reducing the number of redundant components and lowering the overall weight of the bike. The integration of the carbon fiber material with the motor optimizes the weight distribution, thereby enhancing the riding stability and maneuverability.
(2) Efficient heat dissipation and structural stability: The conical rotor cover, combined with the design of the spoiler ribs, actively directs airflow to dissipate the heat from the motor housing, thereby extending the service life of the motor.
(3) Aerodynamic optimization: The smaller end of the conical rotor cover is arranged close to the disc brake mount, thereby reducing the frontal area. The larger end of the conical rotor cover fits the hub, thereby forming a streamlined transition that reduces the air resistance. The spiral arrangement of the spoiler ribs accelerates the outgoing airflow, thereby preventing heat buildup in the motor region.
(4) Functional integration and ease of maintenance: The modular design allows for independent removal of the motor or the rotor cover, thereby cutting down the maintenance cost. The threaded connection design is compatible with hubs of various specifications, thereby facilitating large-scale production and application.

### BRIEF DESCRIPTION OF DRAWINGS

FIG. 1 is an exploded view of the structure of the invention.

FIG. 2 is an exploded view of the structure of the invention from another angle.

FIG. 3 is a schematic diagram of the structure of the invention after it is assembled.

FIG. 4 is a schematic diagram of the structure of the invention after it is assembled from another angle.

FIG. 5 is a schematic diagram of the structure of a motor housing according to the invention.

FIG. 6 is a schematic diagram of the structure of a disc brake mount according to the invention.

FIG. 7 is a schematic diagram of the structure of a rotor cover according to the invention.

FIG. 8 is a schematic diagram of the structure of an end cap and a freehub according to the invention.

### REFERENCE NUMERALS

1 carbon fiber hub
2 motor housing
21 first end of motor housing
22 second end of motor housing
23 abutment flange
3 disc brake mount
31 first end of disc brake mount
32 second end of disc brake mount
33 clamping flange
4 rotor cover
41 spoiler rib
5. retaining ring
6 bearing
7 axle
8 end cap
81 fixing end
9 freehub
10 locking fastener

### DETAILED DESCRIPTION OF THE EMBODIMENTS

In the description of the invention, it should be understood that the azimuth or position relationships indicated by the terms “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, and “counterclockwise” are based on those shown in the drawings. It is only for the convenience of description and simplification of the invention, not to indicate or imply that the referred devices or components must have a specific orientation, be constructed and operate in a specific orientation, and thus cannot be understood as limiting the invention.

Unless otherwise specifically defined, “a plurality of” means two or more in the description of the invention.

In the description of the invention, it should be noted that unless otherwise explicitly specified and limited, the terms “installation”, “provision of”, “fitting over/in”, “connection with”, and “connection to” shall be understood in a general sense. For example, a “connection” may be a fixed connection, a detachable connection, or an integral connection; it may be a mechanical connection or an electric connection; and it may be a direct connection, an indirect connection through intermediate media, or a connection between two elements. For those of ordinary skill in the art, the specific meaning of the preceding terms in the invention can be understood according to specific situations.

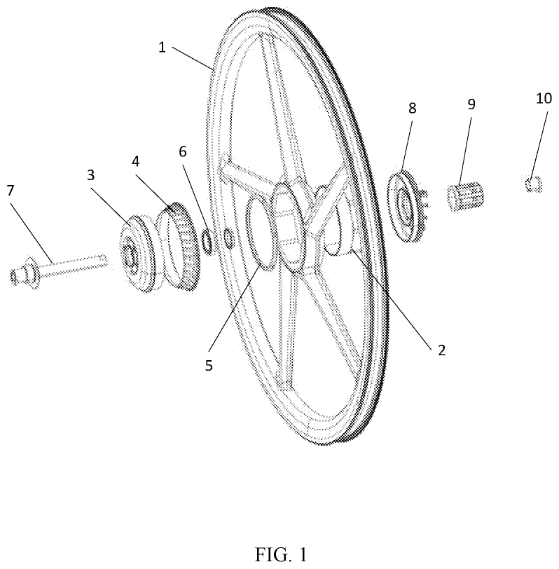

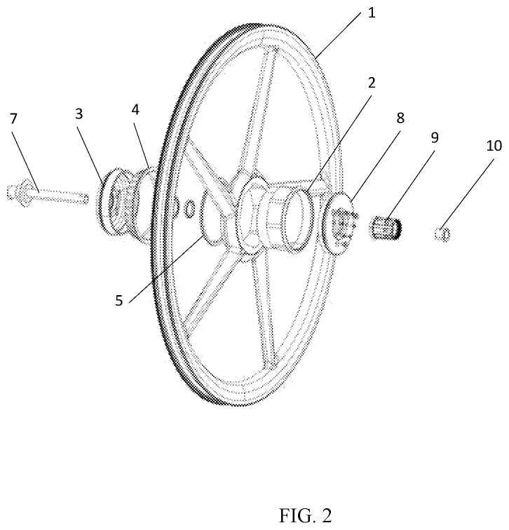

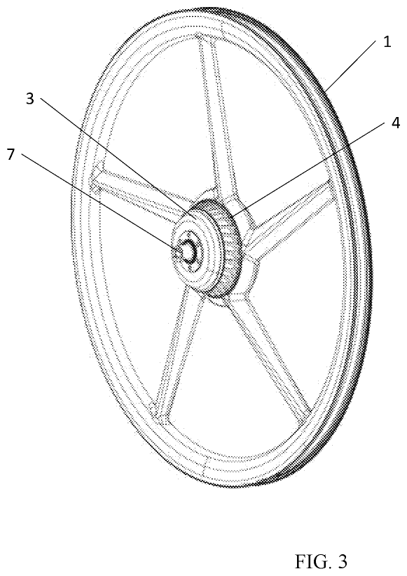

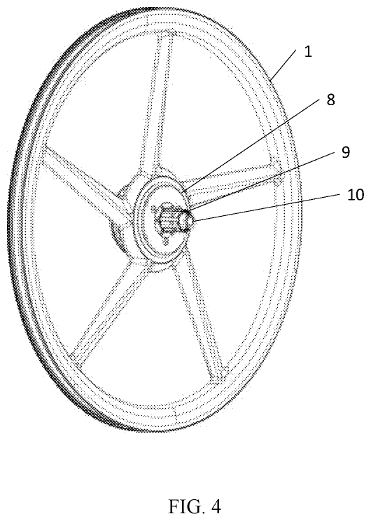

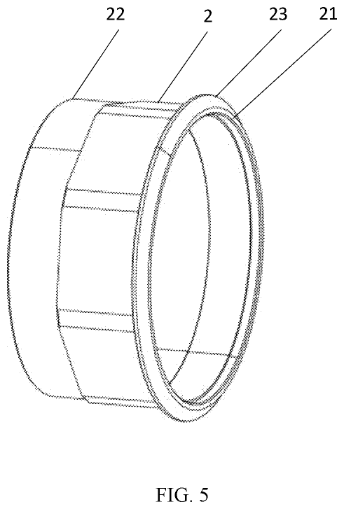

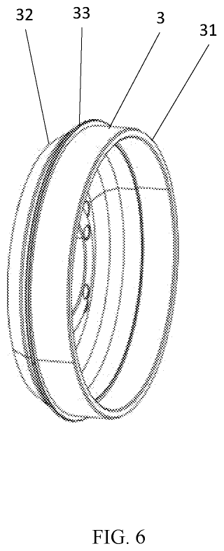

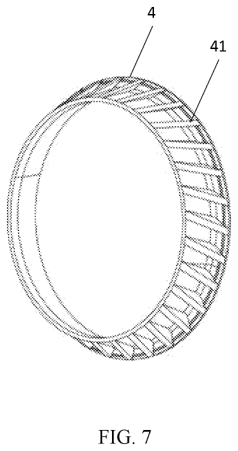

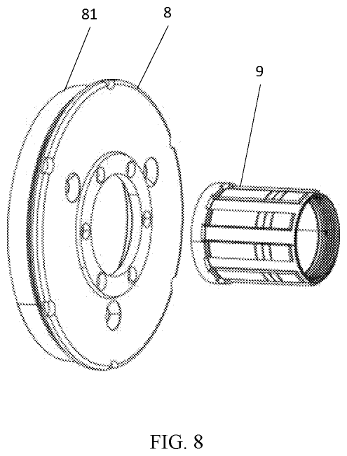

As shown in FIG. 1 to FIG. 8, the invention provides an integrated carbon fiber spoked wheel and motor structure, including a carbon fiber hub 1 and a driving motor (for the sake of simplicity and clarity in the drawings, the internal structure of the driving motor is not shown in the drawings, and those skilled in the art are supposed to understand the relevant internal structural design of the driving motor). The driving motor is arranged at a center of the carbon fiber hub 1 and includes a motor housing 2. The motor housing 2 is bondingly secured to the center of the carbon fiber hub 1 (in the embodiments of this invention, due to the simplified description of the structure of the driving motor, the motor housing 2 represents the mounting position of the entire driving motor); and specifically, epoxy resin adhesive may be used. Further, the carbon fiber hub may also be a spoked hub, particularly a blade-type hub. The motor housing 2 has a polygonal outer contour, which may be a pentagonal, hexagonal, heptagonal, octagonal, nonagonal, or decagonal shape, and the outer contour fits with an inner edge at the center of the carbon fiber hub 1, so the driving motor needs to be mounted at a position at the center of the carbon fiber hub 1 with a shape fitting with the motor housing 2. It should be noted that the internal angle of the polygonal outer contour of the motor housing 2 should not be too large. Specifically, an octagonal shape is adopted in this embodiment. The motor housing 2 further includes a first end 21 and a second end 22. The first end 21 of the motor housing 2 is provided with an internal thread. An abutment flange 23 is provided on the outer circumference of the first end 21 of the motor housing 2. The second end 22 of the motor housing 2 is provided with an external thread. When the driving motor is arranged at the center of the carbon fiber hub 1, the second end 22 of the motor housing 2 protrudes out of one side of the carbon fiber hub 1.

The structure of this embodiment further includes a disc brake mount 3, a rotor cover 4, a retaining ring 5, a bearing 6, an axle 7, an end cap 8, and a freehub 9. The retaining ring 5 is locked from the outside toward the inside at the second end 22 of the motor housing 2, and the motor housing 2 is press-fit secured to the center of the carbon fiber hub 1 by the retaining ring 5 and the abutment flange 23 on the first end 21 of the motor housing 2. The disc brake mount 3 includes a first end 31 and a second end 32. A clamping flange 33 is provided between the first end 31 of the disc brake mount 3 and the second end 32 of the disc brake mount 3. The first end 31 of the disc brake mount 3 is provided with an internal thread, inserted into the rotor cover 4, and locked with the external thread at the second end 22 of the motor housing 2, thereby securing the rotor cover 4 between the carbon fiber hub 1 and the disc brake mount 3 by means of the clamping flange 33. The rotor cover 4 is designed with a conical shape, and the diameter of one end of the rotor cover 4, close to the carbon fiber hub 1, is greater than that of the other end of the rotor cover 4, close to the disc brake mount 3. In addition, spoiler ribs 41 are arranged on a surface of the rotor cover 4, and the disc brake mount 3 and the rotor cover 4 work together to dissipate heat from the driving motor.

The bearing 6 is arranged at a center of the disc brake mount 3, and the axle 7 passes through the bearing 6 and extends into the first end 21 of the motor housing 2. The end cap 8 is arranged at the first end 21 of the motor housing 2, and includes a fixing end 81, which is provided with an external thread that is lockingly secured to the internal thread of the first end 21 of the motor housing 2. One end of the freehub 9 is snap-fit secured to an inner edge at a center of the end cap 8, and the other end protrudes out of the end cap 8.

Further, the integrated structure includes a locking fastener 10, which fits over an end of the axle 7 from the outside of the freehub 9 toward the inside.

With an innovative structural design, this technical solution achieves an efficient integration of the carbon fiber hub 1 and the driving motor. The motor housing 2 features a polygonal contour that fits with the inner edge at the center of the carbon fiber hub 1. With the press-fit structure formed by the retaining ring 5 and the abutment flange 23, the driving motor is tightly secured to the carbon fiber hub 1. This solution overcomes the challenge of integrating a motor into a conventional carbon fiber hub 1 and significantly reduces the overall volume and weight, thereby meeting the requirements for lightweight design. In addition, the threaded design at both ends of the motor housing 2, in conjunction with components such as the disc brake mount 3 and the end cap 8, forms a modular mounting structure that simplifies the assembling process. Moreover, the arragement of the bearings 6, the axle 7, and the locking fastener 10 ensures the stable operation of the powertrain system and prevents loosening during rotation. The design of the conical rotor cover 4, in conjunction with the spoiler ribs 41, not only optimizes the aerodynamic performance and reduces the air resistance, but also enhances the heat dissipation efficiency of the motor by means of the spoiler structure, thereby improving the reliability of the drive system. The modular design allows for independent removal of the motor or the rotor cover, thereby cutting down the maintenance cost. The threaded connection design is compatible with hubs of various specifications, thereby facilitating large-scale production and application.

The above illustrates and describes the basic principles, main features, and advantages of the invention. Those skilled in the art should understand that the invention is not limited by the above embodiments. The above embodiments and the specification only illustrate the principle of the invention. On the premise of not departing from the spirit and scope of the invention, there will be various changes and improvements in the invention, which fall within the claimed scope of the invention. The scope of protection claimed by the invention is defined by the appended claims and their equivalents.

What is claimed is:

1. An integrated carbon fiber spoked wheel and motor structure, comprising a carbon fiber hub and a driving motor; the driving motor is arranged at a center of the carbon fiber hub; and the driving motor comprises a motor housing, wherein the integrated structure further comprises a disc brake mount, a rotor cover, a retaining ring, a bearing, an axle, and an end cap;
the motor housing has a polygonal outer contour that fits with an inner edge at the center of the carbon fiber hub; the motor housing comprises a first end and a second end; the first end of the motor housing is provided with an internal thread; an abutment flange is provided on an outer circumference of the first end of the motor housing; the second end of the motor housing is provided with an external thread; and when the driving motor is arranged at the center of the carbon fiber hub, the second end of the motor housing protrudes out of the carbon fiber hub;
the retaining ring is locked from the outside toward the inside at the second end of the motor housing, and the motor housing is press-fit secured to the center of the carbon fiber hub by the retaining ring and the abutment flange on the first end of the motor housing;
the disc brake mount comprises a first end and a second end; the first end of the disc brake mount is provided with an internal thread, and is lockingly secured to the second end of the motor housing;
the rotor cover is arranged between the disc brake mount and the carbon fiber hub;
the bearing is arranged at a center of the disc brake mount, and the axle passes through the bearing and extends to the first end of the motor housing; and
the end cap is lockingly secured to the first end of the motor housing.

2. The integrated carbon fiber spoked wheel and motor structure according to claim 1, wherein the integrated structure further comprises a freehub, one end of which is snap-fit secured to an inner edge at a center of the end cap.

3. The integrated carbon fiber spoked wheel and motor structure according to claim 1, wherein
a clamping flange is provided between the first end of the disc brake mount and the second end of the disc brake mount; and the first end of the disc brake mount is inserted into the rotor cover and locked with the external thread at the second end of the motor housing, thereby securing the rotor cover between the carbon fiber hub and the disc brake mount by means of the clamping flange.

4. The integrated carbon fiber spoked wheel and motor structure according to claim 2, wherein
the integrated structure further comprises a locking fastener, which fits over an end of the axle from the outside of the freehub toward the inside.

5. The integrated carbon fiber spoked wheel and motor structure according to claim 1, wherein
the motor housing may be of a pentagonal, hexagonal, heptagonal, octagonal, nonagonal, or decagonal shape.

6. The integrated carbon fiber spoked wheel and motor structure according to claim 1, wherein
the end cap comprises a fixing end, which is provided with an external thread that is lockingly secured to the internal thread at the first end of the motor housing.

7. The integrated carbon fiber spoked wheel and motor structure according to claim 1, wherein
the rotor cover is of a conical shape, and the diameter of one end of the rotor cover, close to the carbon fiber hub, is greater than that of the other end of the rotor cover, close to the disc brake mount.

8. The integrated carbon fiber spoked wheel and motor structure according to claim 1, wherein
spoiler ribs are arranged on a surface of the rotor cover.

9. The integrated carbon fiber spoked wheel and motor structure according to claim 1, wherein
the motor housing is bondingly secured to the center of the carbon fiber hub.

10. The integrated carbon fiber spoked wheel and motor structure according to claim 1, wherein the carbon fiber hub is a blade-type hub.
